(19) United States
(12) Patent Application Publication
(10) Pub. No.: US 2021/0217388 A1
(43) Pub. Date: Jul. 15, 2021

(54) Modular marimba frame

(71) Applicant: Walter Oresta White, San Antonio, TX (US)

(72) Inventor: Walter Oresta White, San Antonio, TX (US)

(21) Appl. No.: 17/148,187

(22) Filed: Jan. 13, 2021

Related U.S. Application Data
(60) Provisional application No. 62/960,213, filed on Jan. 13, 2020.

(51) Int. Cl. G10D 13/09

(52) U.S. Cl. CPC G10D 13/09; G10D 13/28

(57) ABSTRACT

The invention relates to a device for supporting a musical instrument, in particular a percussion instrument such as a marimba, xylophone or vibraphone. The device includes a base and support rails. The base has an adjuster for positioning the musical instrument at a desired height and angle. The rails have pins for the bars to rest upon with no contact of frame. The rails are connected in such a way as to allow additional rails to be joined. The joining of support rails extends the length of rail for additional tone bars. These parts are joined as to create a single unit. The frame can be disassembled and convenient for player to transport.

### BACKGROUND

The present invention relates to a device for supporting a musical instrument, in particular a percussion instrument such as a xylophone, marimba or vibraphone, comprising:

a base: and
a support body connected to the base and the musical instrument; wherein the frame comprises support rails which connect to further support rails for extending the length and size to accommodate additional tone bars. The tone bars rest upon pins preventing contact of tone bars with support rails or framing.

Prior art devices have a defined limitation to size. This limitation has a finite size and number of musical tone bars. The present invention extends the frame size and therefore tone bar amount and range. In addition, known devices are bulky and cumbersome for transport, which is a particular shortcoming.

### BRIEF DESCRIPTION OF THE DRAWINGS

The present invention is further elucidated with reference to the figure description of an embodiment herein below. In the drawing:

FIG. 1 is a perspective view of single embodiment of the present invention.

FIG. 13 is a drawing of support device for tone bars according to present invention.

FIG. 18 is an exploded view of method to join rail supports, expanding support length and additional tone bars.

FIG. 26 is a perspective view of present invention displaying height and angle adjustment.

FIG. 39 is a perspective view of an embodiments of the present invention.

FIG. 40 is a perspective view of an embodiments of the present invention.

FIG. 41 is a perspective view of an embodiments of the present invention.

FIG. 42 is a perspective view of an embodiments of the present invention.

FIG. 43 is a perspective view of an embodiments of the present invention.

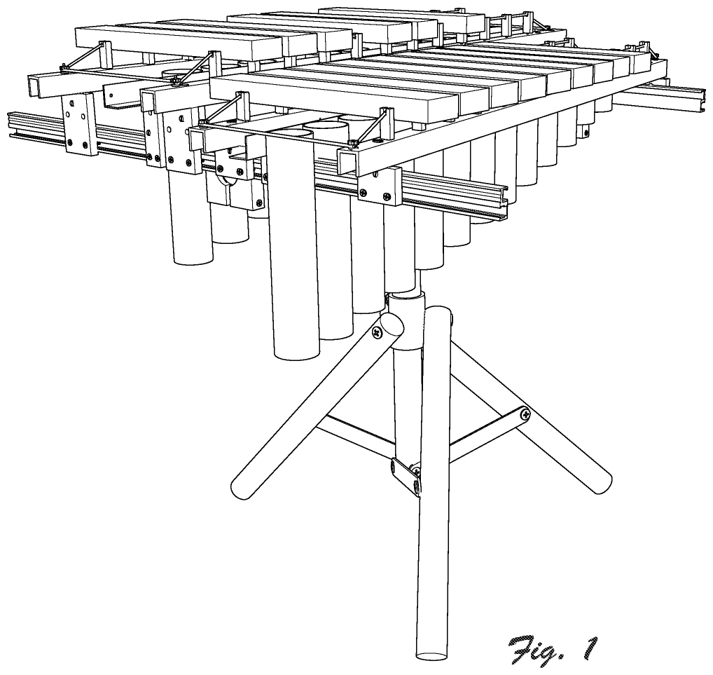

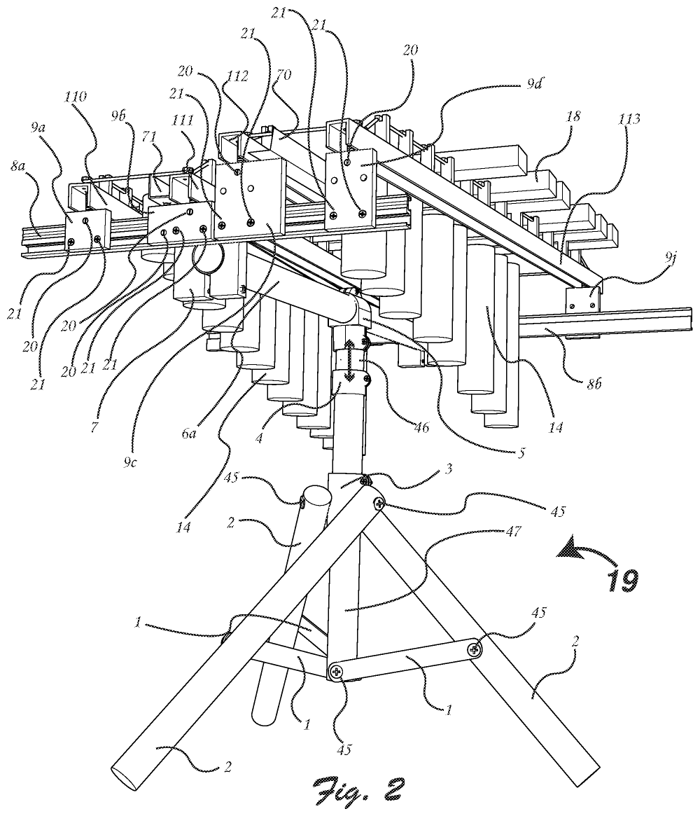

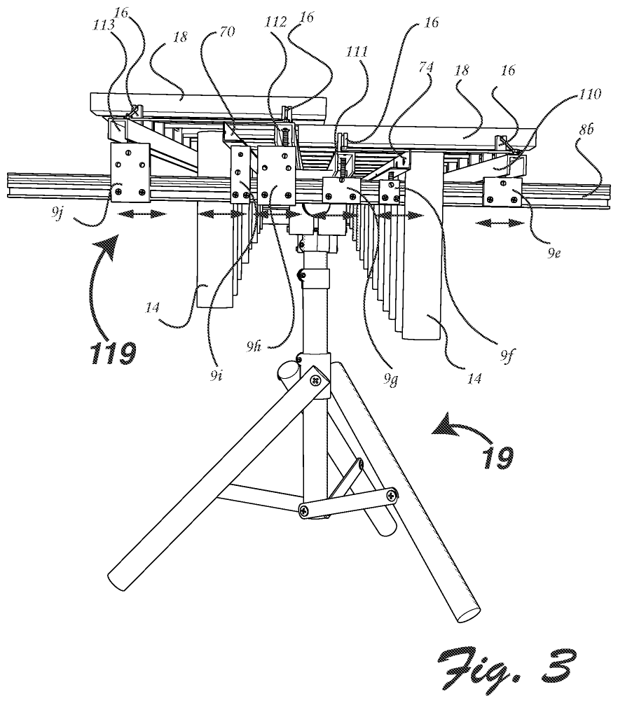

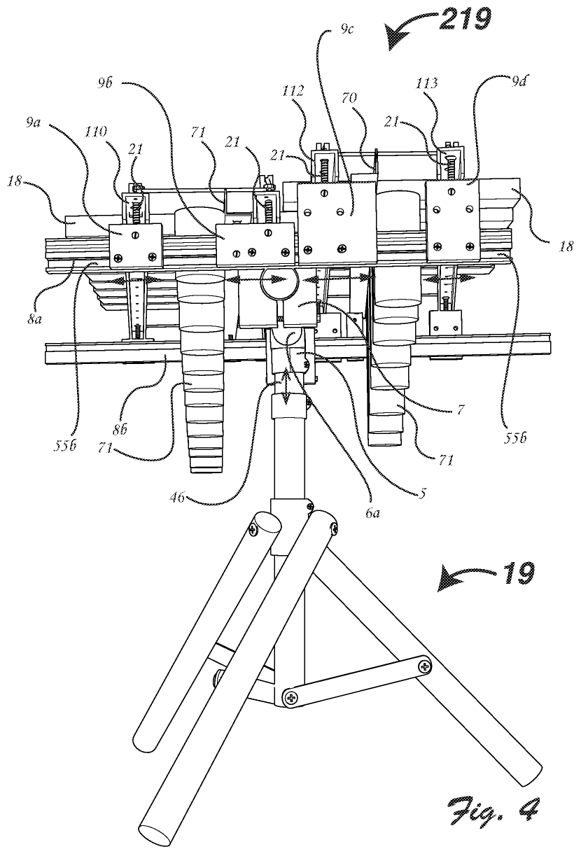

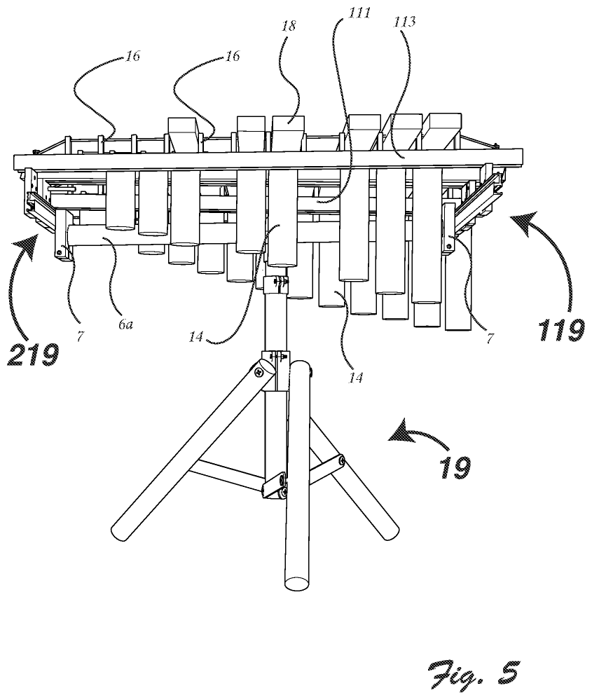

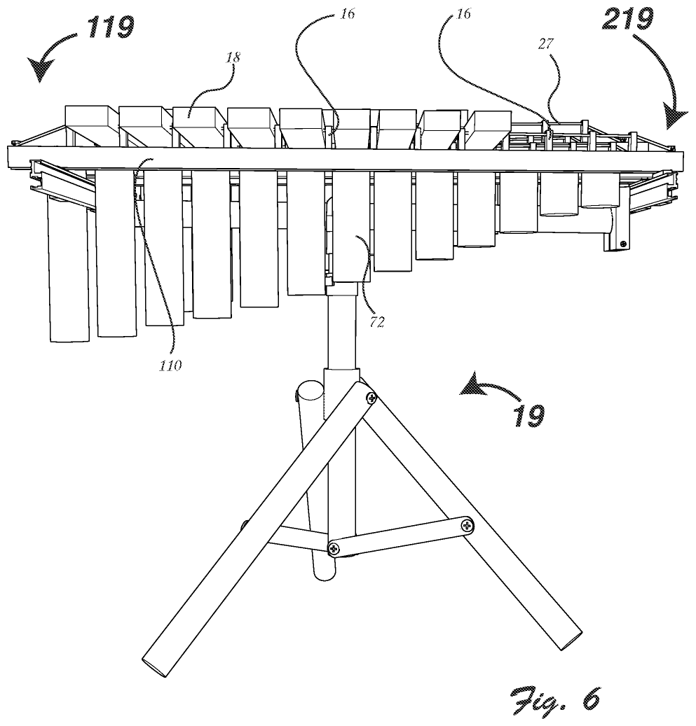

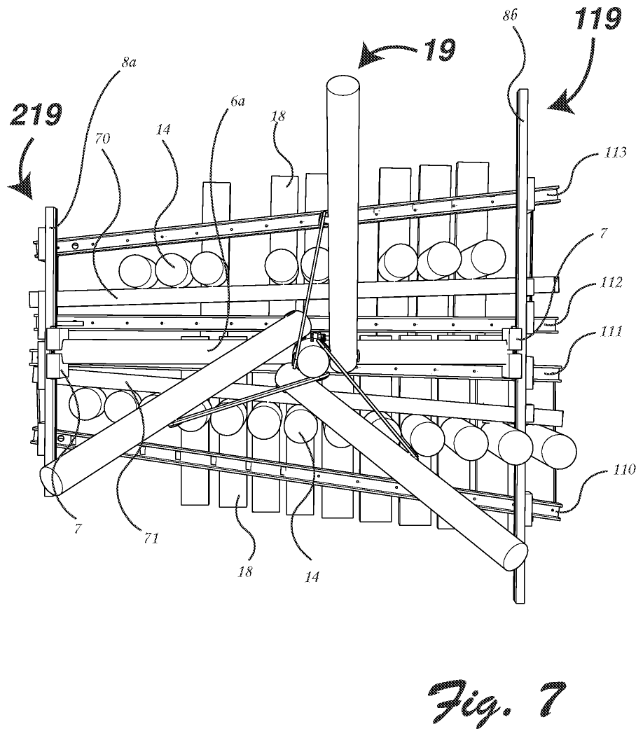

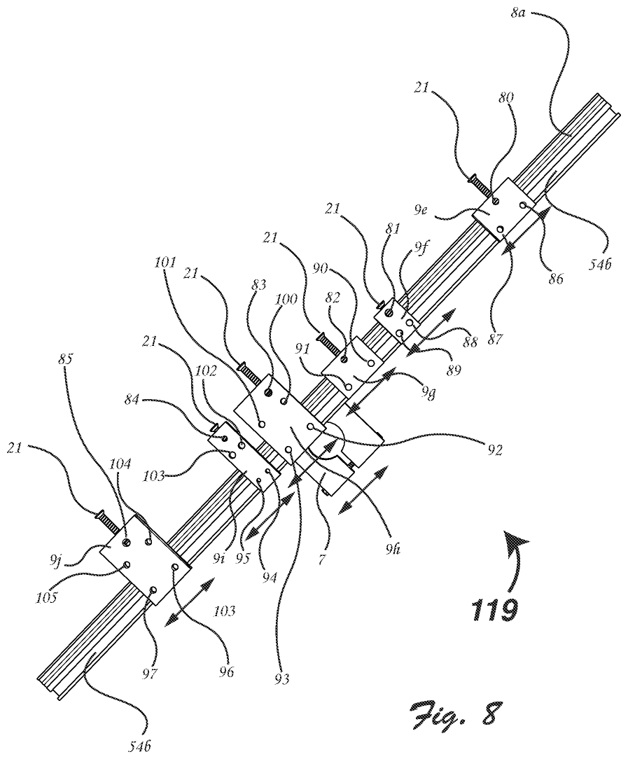

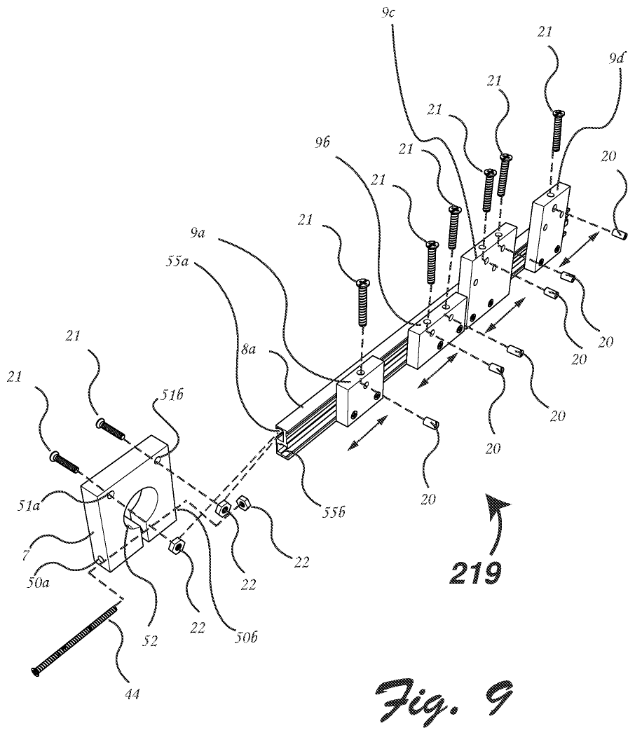

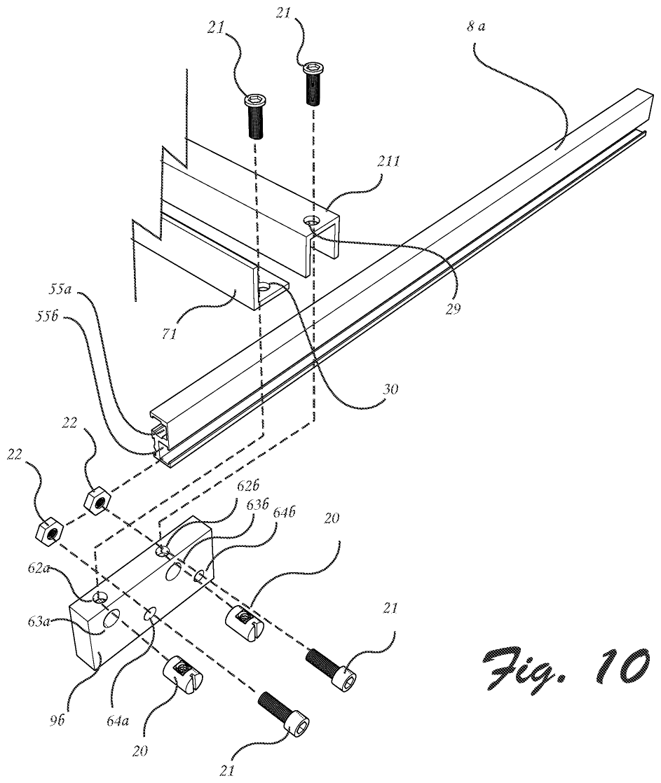

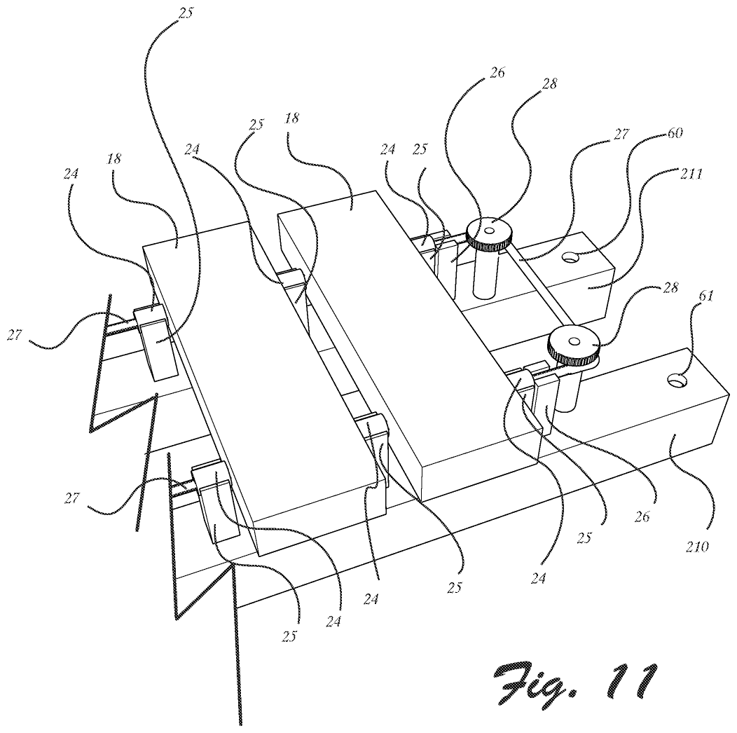

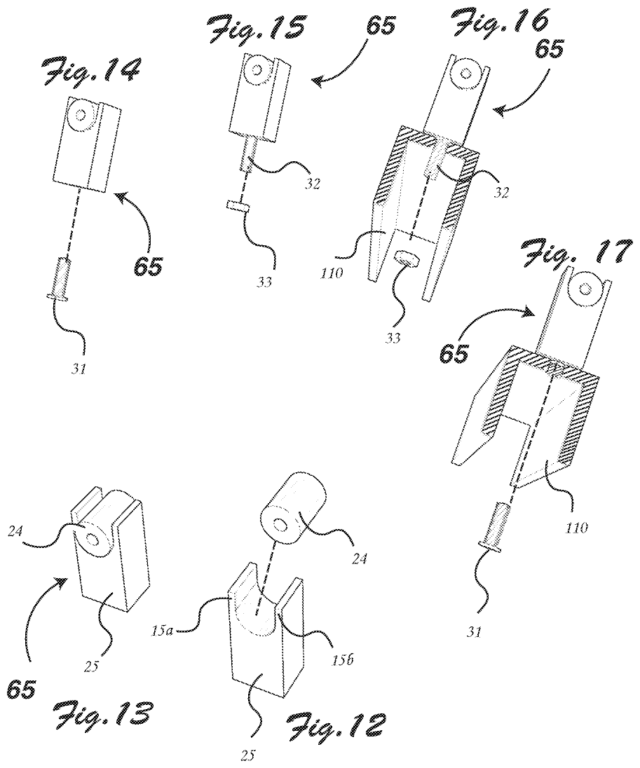

FIG. 1 is a rear oblique perspective of the embodiment of present invention in the first stage before additions. The present invention begins with these basic parts.

FIG. 2 is an oblique view of the present invention: a base comprised of support legs 2 attached to base tube 47 with bracing 1, using threaded fastener 45. Said legs 2 are adjustable with a sliding clamp 3 which slides over tubing 47. Affixed to the top of said tube 47 is a clamp 4 for height adjustment control. Parts 1, 2, 3, 4, 45, 47, 46 comprise the base 19 of the present invention. Sliding within tube 47 is a tube 46 having a T-type connector 9 fastened to its exposed end to hold tube referred to as a spine 6a. Affixed to said spine 6a at the ends are receiving clamps 7 which join said base 19 to the other frame parts. End clamp 7 is attached to end rails 8a and 8b which are constructed with T-slots on opposing faces. The end rails 8a, 8b preferred material in this embodiment is extruded aluminum. The end rails 8a, 8b can be constructed from other material other than extruded aluminum. The material extruded aluminum is preferred material in this embodiment for purposes of weight and strength, although other mediums may be used. The extruded aluminum rails used to construct the end rails 8a, 8b, each having two T-slots 54a, 54b, 55a, 55b, allow the end rail blocks 9a, 9b, 9c, 9d the ability to slide along the length of said rail ends 8a, 8b. This sliding motion allows the end user the ability to customize the arrangement and layout. Affixed to end rails 8a are sliding rail blocks 9a, 9b, 9c, 9d, which are drilled to allow passage of threaded fastener 21 affixing sliding rail block 9a, 9b, 9c, 9d to end rail 8a. Said sliding rail blocks 9a, 9b, 9c, 9d preferred material in the embodiment is HDPE (high density polyethylene). The sliding end blocks 9a, 9b, 9c, 9d may be constructed of other lightweight material, such as carbon fiber, metals or other polymers. Said sliding rail blocks 9a, 9b, 9c, 9d also have installed in the upper area a rod-shaped bolt 20 to allow easy repair. While said sliding support blocks 9a, 9b, 9c, 9d can be machined with threads, the rod-shaped bolt allows for easy repair or service. Said end rails 8a, 8b provide support for bar rails 110, 111, 112, 113, which support musical tone bars 18. Bar resonator tubes 14 are attached to resonator railings 70,71 which are attached to rail blocks 9b, 9c.

FIG. 3 is a side view of the low register end of the present invention. The tripod base 19 has the end rail 8b attached to the base via receiving clamps 7. The end rail 8b has attached sliding rail blocks 9e, 9f, 9g, 9h, 9i, 9j which provide support for said bar rails 110, 112, 113, 114. The musical tone bars 18 are suspended upon support pins 16 which are attached to said bar rails 110, 112, 113, 114. The sliding rail blocks 9e, 9f, 9g, 9h, 9i, 9j are attached via a threaded fastener 21 that slides along the T-slot 54b of the extruded metal ends 8b.

FIG. 4 is a side view of the high register end of the present invention. The upper section sits upon the lower base 19. Affixed to the high-end rail 8a, which is shorter than the low-end rail 8b, are sliding rail blocks 9a, 9b, 9c, 9d. Bar rail support 110 is fastened to sliding end rail via threaded fastener 21 into said rod-shaped bolt 20 in 9a. Said bar rail support 110 is attached to sliding end block 9a with a threaded fastener 21. Said sliding end blocks 9a, 9b, 9c, 9d, are fastened to end rail 8a with threaded fasteners 21, which slide within the T-slot 55b of high-end rail 8a. This movement allows for user's personal preference in spacing. High end rail 8a, sliding rail blocks 9a, 9b, 9c, 9d, and end clamp 7 comprise a group referred to as high end support 219.

FIG. 5 is a front view of the present invention. Sliding rail blocks 9e, 9f, 9g, 9h, 9i, 9j, along with end rail 8b and clamp 7, combine to make the low-end support 119. Said bar rail 113 is fastened to the low-end support 119 and high end support 219, which is fastened to a base 19 with clamps 7 and spine 6a. Musical tone bars 18 are strung with a fabric cord 27 that goes through said musical tone bar 18 at the nodal or non-vibrating sections. Said musical tone bars 18 are suspended upon pins 16 Sheet 2 of 13 that are installed along the length of bar rail 110 at varying distance, based upon width of said musical tone bars 18.

FIG. 6 is a rear or user side of present invention. Bar rail 110 is fastened to low end support 119 and high-end support 219. Said musical tone bars 18 are strung with a fabric cord 27 that runs through the musical tone bar at the nodal or non-vibrating sections of the musical tone bars 18. Said fabric cord 27 is suspended upon pins 16 that are installed along the length of bar rail 110 at varying distances, based upon width of said musical tone bars 18.

FIG. 7 is a bottom view of the present invention. Said musical tone bars 18 are suspended over musical tone bar resonators 14, which are attached to a rail 70, below the sharp musical tone bars 18 and below the natural musical tone bars 18 to rail 71. Bar resonators 14 may be constructed from a paper cardboard tube or aluminum. Resonator rails 70, 71 preferred material in this embodiment of the present invention is aluminum in an “L” shape. Said resonator rails 70, 71 can be constructed of other light-weight materials such as said HDPE or other polymers, such as carbon fiber, fiberglass, aluminum, titanium. Aluminum is used in this embodiment of the present invention to allow minimal material while providing a sturdy support for said resonator tubes 14. Said resonator tubes 14 are attached along resonator rails 70, 71 with threaded rods. The resonator tubes 14 are fastened along the length of bar support rails 110, 111, 112, 113, being fastened to low end support 119 and high-end support 219. Said resonator tubes 14 reinforce the lowest fundamental frequency of said musical tone bars 10. The low-end support 119 and high-end support 219 are fastened to spine 6a via clamp 7 of high-end rail 8a and low-end rail 8b.

FIG. 8 is a view of the low-end support 119 exposing the sliding rail blocks 9e, 9f, 9g, 9h, 9i, 9j. Sliding rail block 9e has two holes 86, 87, allowing said sliding block 9e to be fastened to end rail 8a via its T-slot. Said end rail 8a T-slot 54b allows said sliding rail block 9e to move along the length of said low end rail 8a. A hole 80 is placed in the upper region of said sliding rail bock 9e for placement of a rod-shaped bolt 20 to receive a threaded fastener 21 which fastens said bar support rail 110 to sliding rail block 9e. While said sliding support blocks 9e, 9f, 9g, 9h, 9i, 9j can be machined or molded with threads, the rod-shaped bolt allow for easy repair or service.

Sliding rail block 9f has two holes 88, 89, allowing said sliding block 9f to be fastened to end rail 8a via its T-slot. The T-slot 54b allows said sliding rail block 9f to move along the length of said low end rail 8a. A hole 80 is placed in the upper region of said sliding rail block 9f for placement of a rod-shaped bolt 20 to receive a threaded fastener 21, fastening said sharp bar resonator rail 71 to said sliding rail block 9f.

Sliding rail block 9g has two holes 90, 91, allowing said sliding block 9g to be fastened to end rail 8a via its T-slot 54b. Said T-slot 54b allows said sliding rail block 9g to move along the length of said low end rail 8a. A hole 82 is placed in the upper region of said sliding rail block 9g for placement of a rod-shaped bolt 20. This rod-shaped bolt 20 receives a threaded fastener 21, fastening said bar support rail 210 to said sliding rail block 9g.

Sliding rail block 9h has two holes 92, 93, allowing said sliding block 9e to be attached to end rail 8a via its T-slot 54b. The T-slot 54b allows said sliding rail block 9h to move along the length of said low end rail 8a. Said sliding rail block 9h has two holes 100, 101, placed in the upper region relative to said holes 92, 93, allowing the sliding rail block 9h to be placed in a lower profile to end rail 8a. A hole 83 is placed in the upper region relative to aforementioned holes 100, 101 of said sliding rail block 9h for placement of a rod-shaped bolt 20. This rod-shaped bolt 20 receives a threaded fastener 21, fastening said bar support rail 111 to sliding rail block 9h.

Sliding rail block 9i has two holes 94, 95 allowing said sliding block 9i to be attached to end rail 8a via its T-slot 54b. Said T-slot 54b allows said sliding rail block 9e to move along the length of said low end rail 8a. Said sliding rail block 9i has two holes 102, 103, placed in the upper region relative to said holes 94, 95, allowing the sliding rail block 9h to be placed in a lower profile to end rail 8a. A hole 84 is placed in the upper region relative to said holes 102, 103 of said sliding rail block 9i, for placement of a rod-shaped bolt 20 to receive a threaded fastener 21, fastening said bar resonator rail 70 to sliding rail block 9i.

Sliding rail block 9j has two holes 96, 97, allowing said sliding block 9j to be attached to end rail 8a via its T-slot 54b. Said T-slot 54b allows said sliding rail block 9e to move along the length of said low end rail 8a. Said sliding rail block 9j has two holes 104, 105, placed in the upper region of said sliding rail block relative to holes 96, 97, allowing the sliding rail support 9j to be placed in a lower profile to end rail 8a. A hole 85 is placed in the upper region relative to holes 104, 105 of said sliding rail block 9j for placement of a rod-shaped bolt 20 to receive a threaded fastener 21, fastening said bar support rail 113 to sliding rail block 9j.

FIG. 9 is an exploded view of high-end support 219 elements. The end rail 8a is attached to the base via clamp 7. The preferred construction material for clamp 7 in this embodiment of the present invention is a polymer such as HDPE, (high density polyethylene), or other such lightweight material. Said clamp 7 can be constructed of molded plastic or metal. The hole 52 is sized to accept spine tube 6a, 6b. Two holes 51a, 51b allow threaded fastener passage to receiving thread bolts 22. Said bolts 22 slide into and along the T-slot 55a of rail end 8a. Clamp 7 has holes 50a, 50b for a threaded rod 44 to fasten into a thread bolt 22 which tightens clamp 7 on spine tube 6a, 6b. Clamp 7 maintains the high-end support 219 in a single position while allowing the high-end support 219 to rotate if desired. The ability to rotate the high-end support 219 allows the user to sit while performing

Sliding rail blocks 9a, 9b, 9c, 9d are attached to high end support 219 end rail 8a with threaded fasteners, which slide along the length of end rail 8a via T-slot 55b. Said sliding rail blocks 9a, 9b, 9c, 9d, have a hole in the top end surface to allow a threaded fastener 21 access to a rod-shaped bolt 20. Said threaded fastener 21 fastens bar support rails 110, 111, 112, 113 to their respective sliding rail blocks 9a, 9b, 9c, 9d.

FIG. 10 is an exploded view of sliding rail block 9b elements. The end rail 8a receives in its T-slot 55b bolt 22. Threaded fasteners 21 fasten to receiving threaded bolts 22, which pass through holes 64a, 64b, fastening sliding rail block 9b to end rail 8a via T-slot 55b. Said end rail 8a T-slot 55b allows the sliding rail block 9b to be placed as desired along the length of end rail 8a. A threaded rod 21 fastens resonator rail 71 via a hole 30 into a rod-shaped bolt in hole 63a of the sliding rail block 9b. A threaded fastener 21 fastens bar support rail 211 via a hole 29, into a rod-shaped bolt in hole 63b of the sliding rail block 9b.

FIG. 11 show the musical tone bars 18 suspended with a fabric cord 27 that travels through the musical tone bars 18 suspended within a rubber insulator 24. In FIG. 11, a rubber insulator 24 is floated within a pin 25, fastened to bar support rail 210, 211. The fabric cord 27 is wrapped around an end pin 28, keeping the fabric cord 27 secure. Said pins 25 are secured to the bar support rails 210, 211 from underneath said bar support rails 210, 211. Said fabric cord 27 travels through the rubber insulator 24 with an end pin 26 that does not have a rubber insulator 24. Said guide pin 26 secures the fabric cord 27 in line to the end pin 28. A hole 61 is placed near the end of the bar support rail 210 to allow for a threaded fastener 21 to secure said bar support rail 210 to the sliding rail block 9a. Likewise, a hole 60 is placed near the end of bar support rail 211, for a threaded fastener 21 to secure the bar support rail 211 to bar support block 9b.

FIG. 12 is an exploded view of the rubber insulator 24 that floats within the arms 15a, 15b of the base pin 25. The arms 15a, 15b fit with enough friction on the rubber insulator 24 to prevent bounce. The material used for said rubber insulator 24 is natural rubber latex. While other materials such as natural rubber, thermoplastic elastomer, & synthetic rubber may be used, natural rubber latex is the preferred material.

FIG. 13 shows that the rubber insulator 24 and the base pin 25 comprise the component pin 65.

FIG. 14 is pin 65 with one method of fastening. A threaded fastener 31 enters said pin 65 from below, thereby fastening said pin 65 to item being attached.

FIG. 15 is pin 65 with a second method of fastening. Pin 65 has a threaded fastener 32 physically extruded, or an external threaded fastener, placed into said pin 65 from below.

FIG. 16 is a cutaway view of pin 65, using a fastening method described in FIG. 15. Pin 65 has an extruded threaded fastener 32 or an external threaded fastener 32. Said threaded element 32 passes through bar support rail 110. Pin 65 is fastened to bar support rail 110 by fastener 33.

FIG. 17 is a cutaway view of pin 65, fastened using method described in FIG. 14. A threaded fastener 31 enters pin 65 from below through bar support rail 110, fastening pin 65 to the bar support rail 110.

FIG. 18 is an exploded top oblique view, showing how bar support rail 110 may be joined with bar support rail 210, by fastening a joiner 42 to both bar support rails 110, 210. Bar support rail 110 has hole 506 for a threaded insert 40 to be placed. A threaded fastener 41 is sent through said joiner 42, fastening it underneath said bar support rail 110. A threaded fastener 43 passes through both said bar support rail 110 and said joiner 43 to attach rail to a support block 9a.

Bar support rail 210 has hole 507 for a threaded insert 40 to be placed. A threaded element may be machined or permanently placed. Said method would prevent field service. A threaded fastener 41 is sent through said joiner 42, fastening it underneath said bar support rail 210, which joins bar support rail 110 with bar support rail 210.

FIG. 19 is an example of bar support rail 110 connected by joiner 42 with bar support rail 210. A nearly seamless joint is made. The threaded insert 40 in both bar support rails 110, 210 should have a low profile, so as not to interfere with musical tone bars 18. Threaded fastener 43 should be of a low profile, so as not to interfere with said musical tone bars.

FIG. 20 is an exploded bottom oblique view of how two bar support rails 110, 210 may be joined with joiner 42. Said joiner has 5 holes 501a, 501b, 501c, 501d, 501e, which allows the single joiner 42 to join numerous sections of bar support rails. The assortment of holes in said joiner 42 allows threaded fasteners to pass through to secure said bar support rails to be fastened to their respective support blocks on either low-end support 119 or high-end support 219.

Bar support rail 110 hole 507 holds a threaded insert 40. A threaded fastener 41 runs through the hole 501d of said joiner 42, to fasten to bar support rail 110. A threaded insert 40 is placed in bar support rail 210 via hole 507, fastened with threaded fastener 41 which passes through joiner 42 via hole 501a. In this embodiment of the present invention, threaded fastener 43 passes through bar support rail 110 via hole 508. Hole 501c in said joiner 42 allows passage of threaded fastener 42 to fasten bar support rail 110 to end support 219.

FIG. 21 is an oblique bottom view of two bar support rails 110, 210, connected by the joiner 42. The two bar support rails 110, 210 are fastened together by said joiner 42 with threaded fastener 41, 42. Exposed is threaded fastener 43, which passes through both said bar support rail 110 and said joiner 42. This threaded fastener 43 fastens bar support rail 110 to end support 219.

FIG. 22 is an oblique view of natural musical tone bar resonator tubes 14 attached to rail 71. Said rail 71 has holes 512, 513 to fasten to end support 119, 219. Resonator tubes 14 are arranged along the length or rail 70 as required by musical tone bar 18. The resonators tubes 14 and rail 71 make up the component 519.

FIG. 23 is an oblique view of the sharp musical tone bar resonators. Said tubes 14 are fastened to rail 70 with fasteners 72. Fasteners 72 pass through rail 70 and through bar resonator tube fastening to bolt 73. Said rail 70 holes 511, 512 allow a fastener to pass through, fastening said rail 70 with resonators tubes 14 to end support 219. Resonator tubes 14 are arranged along the length or rail 70, as required by musical tone bar 18 arrangement. The resonator tubes 14 fastened to rail 70, make up the component 619.

FIG. 24 is an oblique view of an embodiment of the present invention in its low position. The base 19 has clamp 4 to govern height of upper frame via tube 46. Clamp 5 holds said spine 6a in a locked rotation position. Said end support 219 can be rotated via clamp 5 or end clamp 7.

FIG. 25 is an oblique view of an embodiment of the present invention with spine 6a and end support 219 rotated.

FIG. 26 is an oblique view of an embodiment of the present invention with spine 6a and end support 219 rotated. The upper frame has height adjustment via clamp 4, allowing tube 46 to adjust up or down.

FIG. 27 is an oblique view of base 19 folded up for transport or storage.

FIG. 28 is an oblique view of the spine 6a and T-connector 5.

FIG. 29 is an oblique view of end support 119.

FIG. 30 is an oblique view of end support 112.

FIG. 31 is an oblique view of bar rail supports 110, 111, 112, 113.

FIG. 32 is an oblique view of natural musical tone bars resonator rail 519 for the natural musical tone bars 18.

FIG. 33 is an oblique view of sharp musical tone bars resonator rail 619 for the natural musical tone bars 18.

FIG. 34 is an exploded view of spine 6a and spine 6b with joiner tube 6c.

FIG. 35 is a bottom view of spine 6a joined with 6b via joiner tube 6c. End support 219 and 119 are fastened to said spine 6a, 6b with clamp 7. Bar support rails 110, 310 are connected by joiner 42 from below. The two end supports, 119, 219, with spine 6a, 6b, are fastened to the said base 19 via clamp 5.

FIG. 36 is a view from the underside of the present invention. The bar support rails are numerous. The joiner 42 is visible in points where it joins bar support rail 110 with bar support rail (abbreviated further on as BSR) 210. BSR 110 is further joined with joiner 42 and BSR 310. BSR 310 is connected by joiner 42 with BSR 410. These four sections BSR 110, BSR 210, BSR 310, BSR 410 make a longer extended BSR. This method allows the user to start with a model of a smaller range of musical tone bars, and to continue to add BSR's as needed. Each BSR 110, 111, 112, 113, can be added with a joiner 42 which adjoins additional BSR's. Each said BSR is fastened to the end supports 119, 219.

FIG. 37 is a view of the base 19 with the additional parts to expand the basic embodiment of the present invention. As shown in FIG. 34,35, the spine 6a can be lengthened by using an inner tube 6c and a spine tube 6b. Said spine 6a, 6b, 6c are attached to the end supports 119, 219 by the end clamp 7, via a T-slot 54b, 55b. The spine 6a, 6b rests on tube 46, which has height control via clamp 4. The end supports 119, 219 can be rotated either at clamp 7 or at the T-connector 5. Clamp 5 allows the spine to be moved along its length or rotated, thereby balancing the weight of the elements attached to the base tripod 19.

As the unit is increased in range, weight becomes an issue for the low register low end support 119. From a leg 2 of the tripod base 19, a hinge 34a, 34b is clamped via threaded fastener 21. Clamp 34a rotates around the tripod base leg 2, as well as travels up and down the length of said tripod leg 2. Clamp 34b rotates, giving the combined parts complete rotation angles. Clamp 34b has one end of tube 35 fastened with a threaded fastener. Tube 35 has a clamp 38 at its end, which holds tube 36 at a desired point to adjust height. Said tube 36 extends to each a clamp 34c, fastened to end support 119. The upper clamp 34c holds a cylinder 37 that receives tube 36. Tube 36 is fastened in cylinder 37 which is fastened to clamp 34c. Clamp 34c travels along the length of end rail 8a via a T-slot 54a. The said clamp 34c is held in place by a threaded fastener 21, which is fastened to clamp 34c with a threaded fastener 44. With the combined angles available with clamps 34a, 34b, 34c and the height control clamp 38, this embodiment of the present invention is capable of being placed in a multitude of desired angles.

FIG. 38 is an oblique top view of expansion points of the present invention. All parts rest and are fastened to end support 119 and end support 219. End supports 119, 219 are attached to the spine 6a, 6b with end clamp 7. Said spine is fastened to the base tripod 19 with a T-clamp 5. BSR 113 is fastened to end support 219. The other end reveals joiner 42 fastened to BSR 113, also exposing its opposite end to fasten to another BSR. BSR 112 is shown joined with BSR 213, which is fastened to end support 119. At the end of BSR 312 is the exposed part of joiner 42. The attached BSR 112 also has an exposed joiner 42. Exposed are three joiners 42, where they would rest to join four BSR units. In the lower part of the figure a BSR containing four individual BSR's, 110, 210, 310, 410. All four become one unit with the joiner 42.

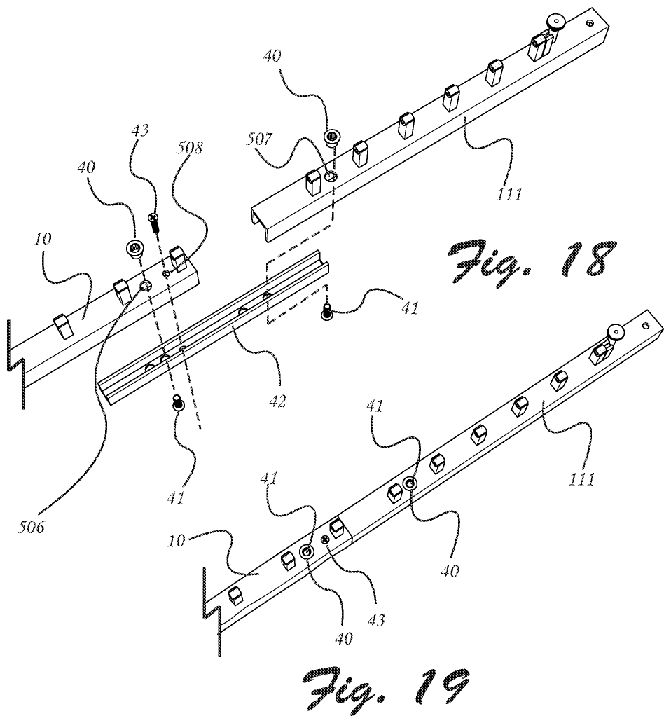

FIG. 39 is the starting embodiment of the present invention called the modular frame. The register in this embodiment is a beginner's instrument with the register of a 9th musical tone bars 18.

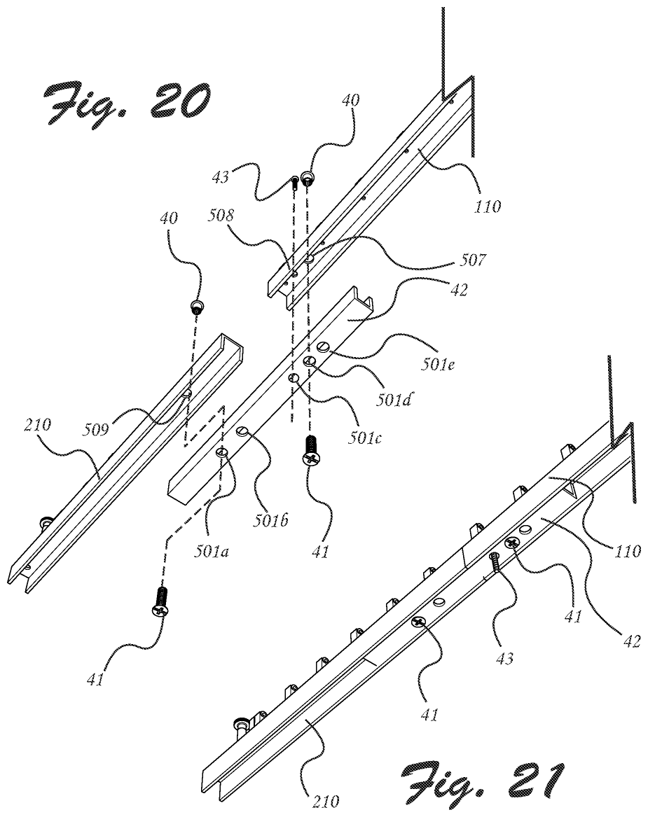

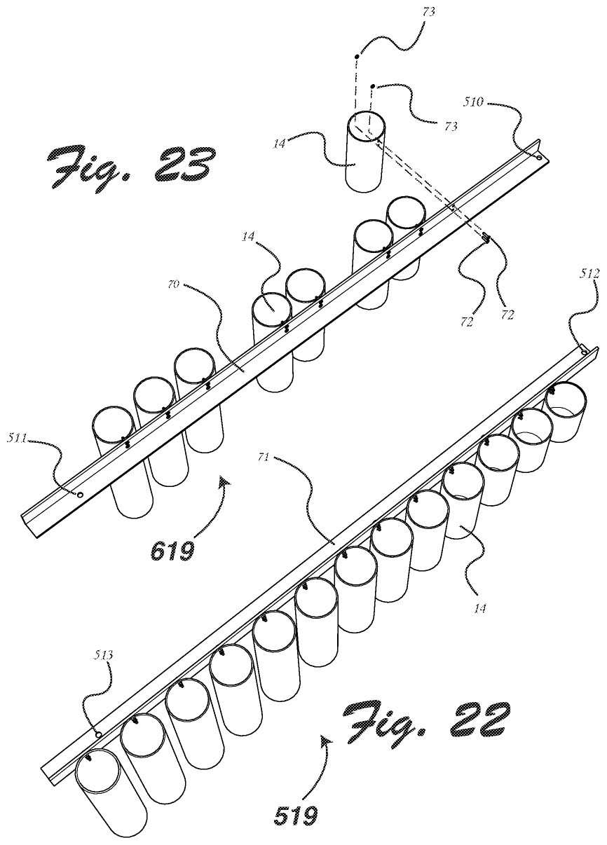

FIG. 40 is the embodiment of the present invention, the modular frame. This is the beginner instrument mentioned in FIG. 39, plus an addition in the upper musical register.

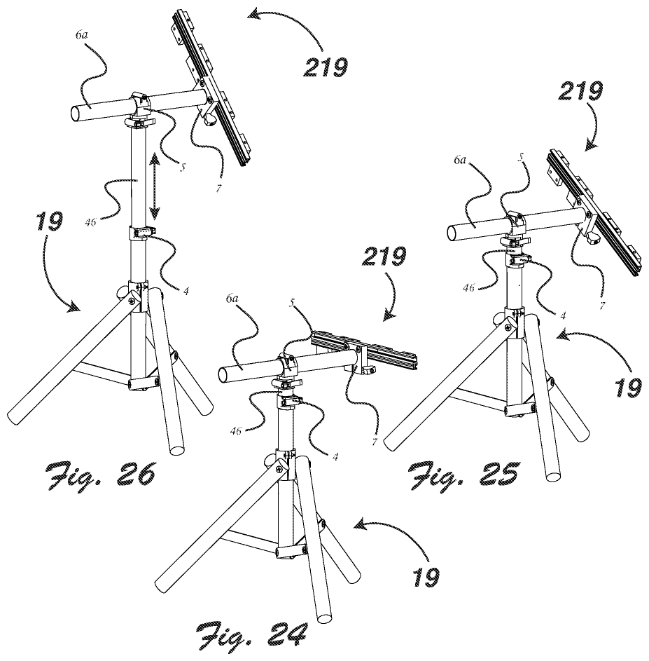

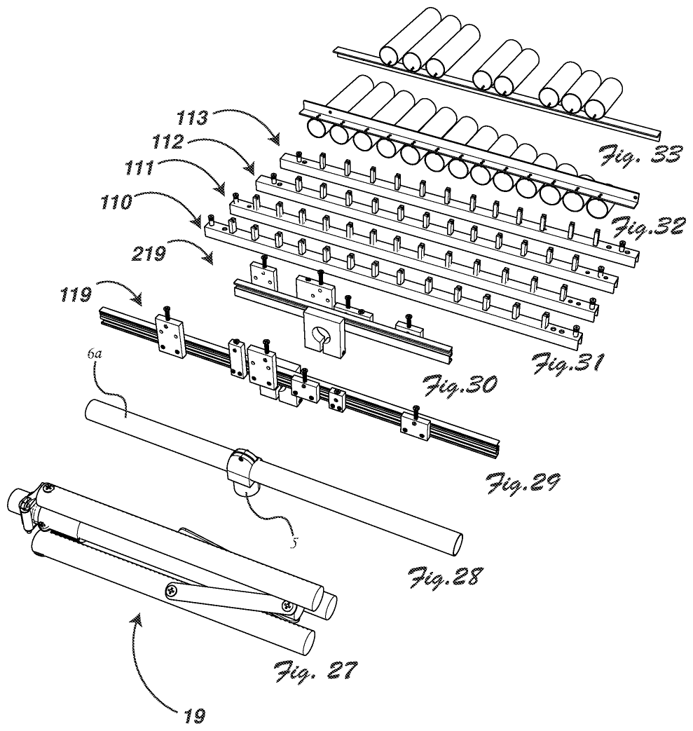

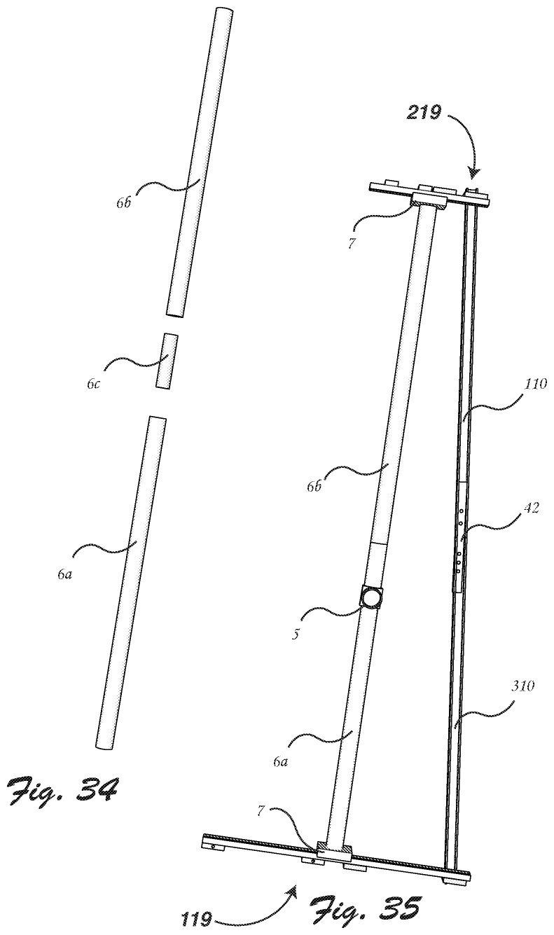

FIG. 41 is the embodiment of the present invention, the modular frame. This embodiment is a further expansion using the joiner 42 to add musical register. FIG. 41 is an addition to FIG. 39 and FIG. 40.

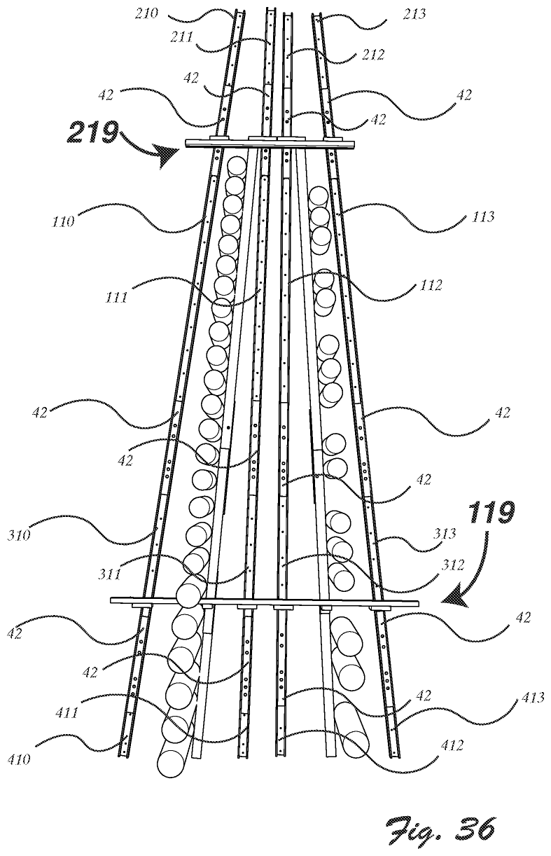

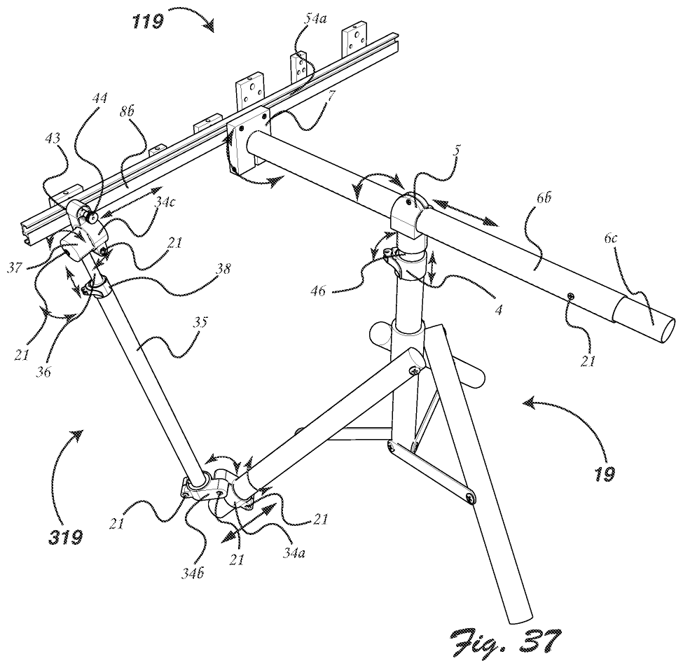

FIG. 42 is the embodiment of the present invention, the modular frame. This embodiment is a further expansion, using the joiner 42 to add musical register. FIG. 42 is an addition to FIG. 39, FIG. 40, and FIG. 41.

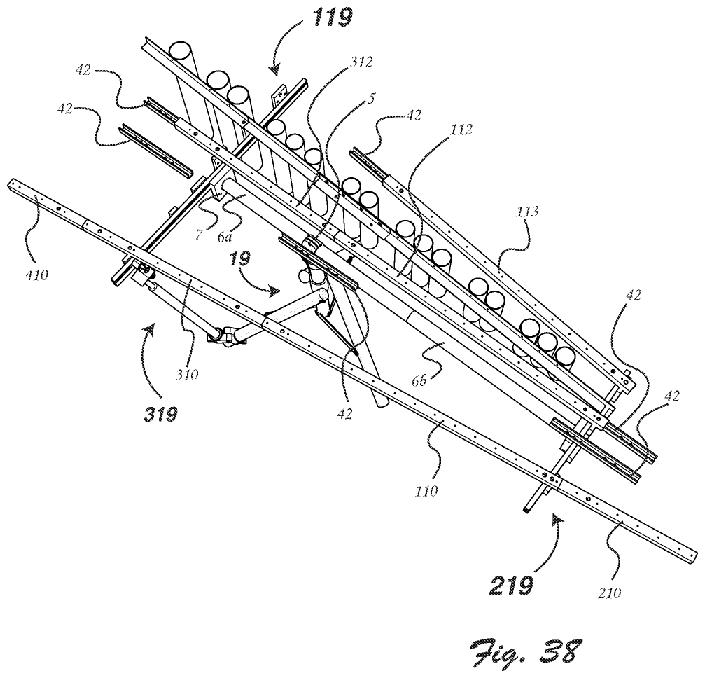

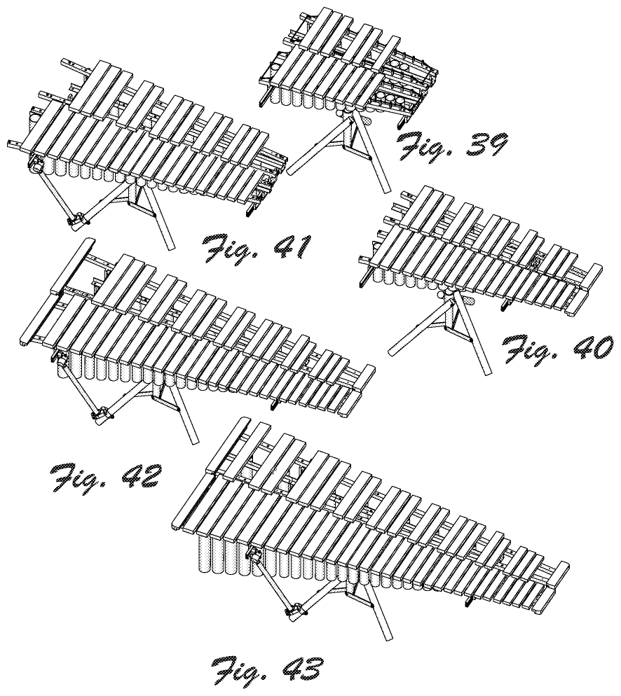

FIG. 43 is the embodiment of the present invention the modular frame. This embodiment is a further expansion using the joiner 42 to add musical register. FIG. 43 is an addition to FIG. 39. FIG. 40, FIG. 41, and FIG. 42.

The invention claimed is:

1. A percussion musical instrument frame comprising of
a base; and
a frame of support rails capable of being extended by attaching additional support rails by means of a joiner, with attached tone bar support pins floating the instrument tone bars; wherein the base with adjustment for desired height and angle of the musical instrument joined with upper rail support frame joining of parts to form an expandable unit.

2. Device as claimed in claim 1, supporting rails for tone bars are extended by attaching additional support rails with a jointer, and with this extension supports additional tone bars.

3. Device as claimed in claim 2 that further includes tone bar suspension pins that cradle and support the tone bar.

4. Device as claimed in claim 4 suspends tone bar as to prevent frame contact allowing the tone bar to vibrate unimpeded.

5. Device as claimed in claim 1 with its parts being able to dismantle to smaller packing for the player to transport.

6. Device as claimed in claim 2 the ability to extend the length of the support rails for supporting the tone bars allows multiple embodiments.
